(19) United States
(12) Patent Application Publication
(10) Pub. No.: US 2021/0209265 A1
(43) Pub. Date: Jul. 8, 2021

(54) Mathematical modelling method for single spool turbojet engine

(71) Applicant: VIETTEL GROUP, Ha Noi City (VN)

(72) Inventors: VAN SON PHAM, Ha Noi City (VN); QUANG HAI NGUYEN, Ha Noi City (VN); CONG ANH PHAM, Xuan Truong District (VN); TRUONG GIANG NGUYEN, Ha Noi City (VN)

(73) Assignee: VIETTEL GROUP, Ha Noi City (VN)

(21) Appl. No.: 16/920,530

(22) Filed: Jul. 3, 2020

(30) Foreign Application Priority Data
Jan. 2, 2020 (VN) 1-2020-00033

(51) Int. Cl. G06F 30/20; F02C 7/00; G01M 15/14; G06F 30/15

(52) U.S. Cl. CPC G06F 30/20; F02C 7/00; G06F 2111/10; G06F 30/15; G01M 15/14

(57) ABSTRACT

A method for building a single-spool jet engine model consisting of five detailed steps: step 1: determining the structure of a turbojet engine to be modeled; step 2: Determine the thermodynamic information of the engine in detail; step 3: Put the engine information into the corresponding component module blocks, model structure according to the multi-loop algorithm and test the engine at the design point in a steady state; step 4: From the entire engine state at the starting point, save the sample as input to the dynamic model, describe the engine operation between the two stable operating points; step 5: Compare test data to make model errors and change unknown values to complete the model. With open source code for customizing and upgrading engine component modules, an open environment for research and development is provided, intended for research subjects of gas turbine engines used in industrial as well as aviation.

### FIELD OF THE INVENTION

The invention is directed to a mathematical modelling method for single spool turbojet engine. Specifically, the method of building a single-spool turbojet engine modeling mentioned in the invention is applied in the field related to thermodynamic system simulation.

### TECHNICAL STATUS OF THE INVENTION

The first single-axis turbojet engine (turbojet) operating on the aircraft was independently and simultaneously designed by engineers Sir F. Whittle (England) and Hans von Ohain (Germany) in the first half of 1990s. Unlike the piston engine used in the air force at the time, the need to increase flight speed and reduce the amount of engine that provided the thrust needed gave the turbojet engine in particular and jet engines in general, in a period of strong development to date. An important component in any flying object, a jet engine is a component that is always developed to achieve stability, fuel efficiency, environmental friendliness (emissions and noise).

Refer to FIG. 1, air is drawn in from station 1 (inlet) to station 2 (compressor head), the pressure is increased when passing through the compressor to the station 3 (compressor exit), pressurized air and fuel burn in combustion chamber, high energy gas flow pass through turbine stage, expanding and generating power. Extracted energy is used to drive compressor, the remaining energy of gas flow is expanded to create a large airflow velocity at the output of the station 8 (subsonic nozzle) or station 9 (supersonic).

Along with the development of electronic computers and algorithm development, the need for control and monitoring the operating status of the engine accurately to maximize the efficiency and complexity of the dynamic system (as well as their modeling to more accurately describe the performance of real engines) has also increased. In many cases, the complexity that comes from the integration of multiple component modules is developed in environments with different programming languages. The design and research of control systems is influenced by the complex integration caused by the need to perfect the independent and complete mathematical model in the same control system design environment. An effective way to overcome this challenge is to build the entire system on a single environment, allowing model and control system developers to work together, such as MATLAB/Simulink. MATLAB is a design tool commonly used by engineers and researchers, including the graphics block programming language on the Simulink complementary library, designed to simulate system activity.

The thermodynamic process simulation tools of jet engines currently available on the market are paid software, closed source code and a part of which does not allow integration and design of control systems. The well-known tools include Numerical Propulsion System Simulation NPSS-NASA, turbine engine software (GasTurb, TurboLib) and system model software, 40,000 pound dynamic system (Commercial Modular Aero-Propulsion System Simulation 40,000 C-MAPSS40k -NASA). NPSS software is a powerful and reliable platform in which jet engines can be created separately. Based on the same source code as C, the NPSS software allows modification of the physics of the jet engine, which can then be linked to a larger system. However, NPSS software or C-MAPSS40k software are not allowed for trial or purchase, but only for certain users, and linking to other platforms, such as the additional Simulink library. The GasTurb software, a gas turbine engine modeling program that provides a user-friendly interface, can be used in jet engine modeling. While providing a more intuitive interface than NPSS software, this product also requires users to work on an independent software package for engine performance analysis. In addition, linking the GasTurb software with other software will be a challenge, as this package requires its own dynamic link library (DLL) for cross platform integration. The Simulink ThermoLib additional library includes computational blocks that allow the development of thermodynamic processes on the Simulink library, but access to library's source code is not allowed, so the upgrade process and updating model blocks is not possible in this environment.

Existing solutions include vendor-restricted tools, or commercial software that limits developers to customize source code. This limits the ability to develop a specific software based on the software provided, the ability to use useful tools on MATLAB/Simulink and exchange data with the third software, integrating the software into the system or interface with other engineering group.

### TECHNICAL BACKGROUND OF THE INVENTION

The purpose of the present invention is to provide a method for constructing a single-spool jet engine to overcome the limitations mentioned. To achieve the above purpose, the proposed method consists of five detailed steps as follows: step 1: determine the structure of the jet engine modeled; step 2: Determine the thermodynamic properties of the engine in detail; step 3: Put the engine configuration into the corresponding component module blocks, model structure according to the multi-loop algorithm and test the engine at the design point in a steady state; step 4: From the entire engine state at the starting point, save the sample as input to the dynamic model, describe the engine operation between the two stable operating points; step 5: Compare test data to make model errors and change unknown values to complete the model.

Single-spool turbojet engines are composed of the main component link as shown in FIG. 2. Each module is regarded as an individual function with inputs and outputs. The environmental module describes the environmental conditions by measured parameters such as altitude, temperature, Mach number and air mass flow rate at inlet. The combustion chamber module converts the energy of the burned fuel into the gas stream. The compressor module compresses the air stream to higher pressure and to a higher temperature based on the energy supplied by the gas turbine engine. The turbine module extracts energy from the hot air stream after the combustion chamber to provide power for the compressor to operate. The duct module simulates airflow with total pressure loss through passage. Shaft module links rotary modules together. The nozzle module expands the airflow behind the turbine, producing a jet with high-speed gas flow.

For each state of the engine, the input and output variables need to perform “guess and target” loops to find the actual engine state in action. The variables involved in the guessing operation include the input variables of each module block regardless of the user-set constant; the target variables include the output errors of the module blocks.

Refer to FIG. 3, the model of the use of the multi-loop structure in turbojet engine operation simulation, including the outer loop in time t and the inner loop in the “guess” variable at each discrete loop k. The inner loop includes all of the component modules that exist in unbalanced thermodynamic states, such as turbines, compressors and nozzle. Engine parameters showing unbalanced state f (x(k)) are taken from the engine model to the technique of loop analysis. The loop-solving technique then adjusts parameters as predictive variables to bring the engine to thermodynamic state in equilibrium with the input variables and then returns to the engine model X_il(k+1). The experimental technique pauses the time variable of the engine model, then with the “while” loop allowed at each time the error converges to the allowable value, then increases the model's time to “dt”. Components in the outer loop have a role to integrate the system over time or discrete cumulative over time. External influences include parameters of the environmental conditions acting on the motor's inlet.

### BRIEF DESCRIPTION OF THE DRAWINGS

Illustrations of the invention are described with reference to figures attached hereto. In the figures, identical structures, elements or parts that appear in more than one figure are generally labeled with the same numeral in all the figures in which they appear. Dimensions of components and features shown in the figures are not necessarily shown to scale.

FIG. 1 Basic component of single spool turbojet.

FIG. 2 Single spool turbojet engine mathematical structure.

FIG. 3 Schematic of multi-loop solver in turbojet engine simulation.

FIG. 4 Schematic of building process.

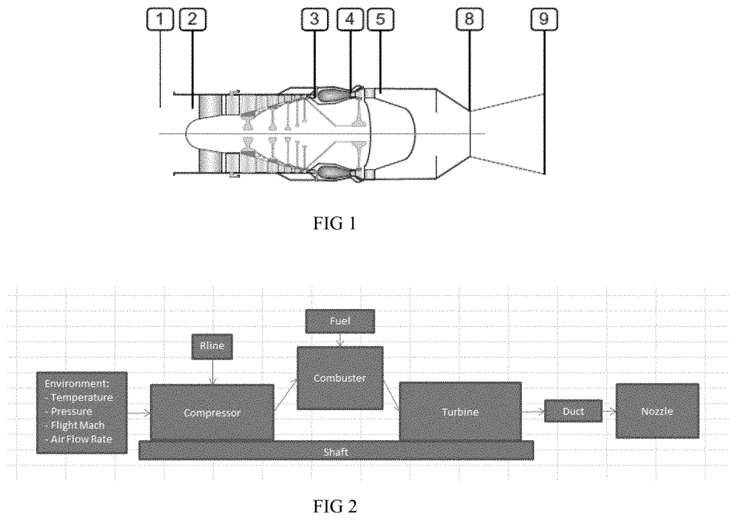

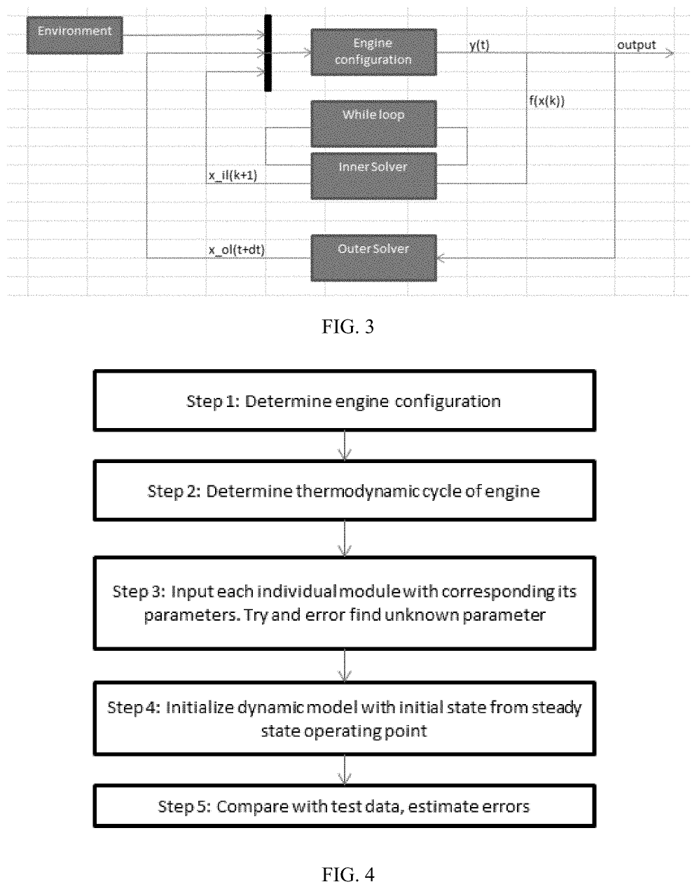

### DETAILED DESCRIPTION OF THE INVENTION

The invention provides a method to build a single spool turbojet engine model. Component modules are the core of the model, when each component module describes physical objects in detail, the model will be more adaptable and customizable and more accurate. The method proposed by the invention uses the following component modules:

Environment.

The medium is used to convert environmental condition data such as altitude, ambient temperature difference from standard conditions, Mach numbers to thermodynamic “languages”: total enthalpy, total temperature and total pressure. The static pressure (Ps) and the static temperature (Ts) are determined from the experimental model according to flight altitude and Mach (MN) number. The total temperature (Tt) and total pressure (Pt) are determined based on the entropy isometric equation on equations (1) and (2) with the assumption of the specific heat ratio (gamma).

In which:

Gamma is the average calculated in each thermodynamic transfer process.

Enthalpy is a thermodynamic state function of thermodynamic system, having the dimension of energy; entropy is a measure of the heat dissipation and absorption when a physical system transitions at an absolute temperature.

$$\begin{matrix}\frac{{T}_{t}}{{T}_{s}} = 1 + \frac{γ - 1}{2} M {N}^{2} & ( 1 ) \\ \frac{{P}_{s}}{{P}_{t}} = {( 1 + \frac{γ - 1}{2} M {N}^{2} )}^{\frac{γ}{γ - 1}} & ( 2 )\end{matrix}$$

Enthalpy was determined experimentally from the interpolation of tables of enthalpy values that vary with a set temperature. If the operating gas has more combustion product, the model automatically calculates based on the characteristics of the Jet-A1 fuel. The other component modules, enthalpy are also calculated similarly.

The combustion chamber has the function of generating energy from burning fuel, and transferring the combustion energy into the gas stream that moves to the turbine input. The value of combustion energy is determined based on the average enthalpy based on the mass of combustion air inlet (htair) and the lower heating value (LHV) of the fuel with the effect of combustion efficiency (n_{b}), based on the fuel-air ratio (FAR) as shown in equation (3). The total enthalpy of air and flux is calculated the same as at the environmental module.

hₜ₋ₜₐₖ=hₜ₋ₐᵢᵣ(1−FAR)+LHV*FAR*n_{b} (3)

Compressor.

The compressor component in a turbojet engine increases the pressure of the engine inlet air stream, which can be designed with a variety of compressors: axial, centrifugal, axial-centrifugal, or fans. Regardless of the compressor type, modeling a single-axis jet engine treats the compression process as adiabatic, and is characterized by a performance map, identifying the relationships between the corrected air flow (Wc), pressure increase coefficient (PR) for each unique value of corrected speed value (Nc) and R-line, the only line on the Wc and PR contact compressor map. Once a pressure and efficiency (Eff) of compressor is determined, the temperature can be calculated based on the enthalpy and entropy tables. The power supplied to the compressor is a function of the enthalpy change when passing through the compressor, the gas flow as shown in equation (4). The torque needed to maintain the current speed value, which should be provided from the machining component such as a turbine, is determined by the function of power and rotational speed (Nmech) as shown in equation (5). In some compressors, air is extracted, and used to cool turbines, provide air to the cabin, and the purposes of using the air in the propulsion systems of the flying object. This amount of extracted air needs to be modeled by removing air flow at the compressor.

$$\begin{matrix}Power = W Δ {h}_{t} & ( 4 ) \\ Torque = \frac{Power}{N m e c h} & ( 5 )\end{matrix}$$

The compressor surge margin is calculated based on formula (6). The compressor surge margin is an important parameter of the engine, showing how the engine is operating far from the operating limit in the engine stabilization area.

$$SurgeMargin ( \% ) = \frac{SPR - PR}{PR} * 100 \qquad ( 6 )$$

Duct.

The duct component is involved in the thermodynamic process as a loss of total pressure, with a constant total temperature value (adiabatic process). This component is simply modeled by multiplying the total pressure by the coefficient of leakage.

Air intake.

The air intake operates to direct the flow to the front of the engine compressor and is modeled using an empirical formula as the total pressure loss compared to the total pressure of the air stream from outside the environment in a variable manner corresponding to the flight conditions.

Nozzle.

The exit nozzle acts on the environment, creating the thrust of the engine from the jet of the air against the engine by the action of the large airflow rate isothermally extended at the throttle. The nozzle model requires many components in the same loop, experimental interpolation tables, and physics-based mathematical formulas. The first step in determining the thrust is the loop algorithm to find the solution for flow velocity, static pressure, static temperature of the flow at the throat of the nozzle with assumption of Mach number 1, then using the relationship. The system is described in equations (7) and (8).

$$\begin{matrix}velocity = \sqrt{2 ( {h}_{t} - {h}_{s} )} & ( 7 ) \\ M = \frac{velocity}{\sqrt{γ R {T}_{s}}} & ( 8 )\end{matrix}$$

Once velocity, static pressure and static temperature are determined, the value of flow rate and thrust can be calculated based on equation (9) (10) (11), with R—gas constant specific, p—density, Ath—throat output area, g—gravitational acceleration, W—air flow.

$$\begin{matrix}ρ = \frac{{P}_{s}}{R {T}_{s}} & ( 9 ) \\ W = ρ * velocity * Ath & ( 10 ) \\ thrust = \frac{W}{g} velocity + ( {P}_{s} - {P}_{a} ) Ath & ( 11 )\end{matrix}$$

Shaft.

The shaft provides a connection for turbines and compressors. The acceleration of the rotor is calculated as the sum of the input torque divided by the moment of inertia of the rotor according to equation (12).

$$Ndot = \frac{\sum Component Torque}{2 π I} \qquad ( 12 )$$

Turbines.

Turbines are designed to extract energy from the air stream by expanding hot gas through the rotor blades. Like compressors, the thermodynamic process in a turbine is considered to be adiabatic, and is described by the operation map with the relation of the thermodynamic parameters (Wc) and the turbine pressure ratio (PR). Correlates with each value that converts shaft speed and turbine efficiency, turbine enthalpy, torque and power temperatures are calculated similarly to compressors, as detailed in Equations (4) and (5), with differences in power and torque generated to drive the compressor. In many cases, the airflow into a turbine has a temperature high enough to cause failure to the mechanical structure of the turbine blades. Therefore, the turbine needs cooling because of the addition of cool air behind the compressor, so the thermodynamic process in the turbine model has a change in flow value.

With the above basic data, the method of building a single-spool turbojet engine modeling consists of five steps with the following details:

Step 1: Determine the structure of the turbojet engine modeled.

At this step, the structure of the turbojet engine is modeled including the number of spool, bleed for cooling mode and air-supply mode, with afterburning mode, power consumption for auxiliary components, environmental conditions parameters. The turbojet engine structure is determined based on the modules at the technical background of the invention. The structure determination is based on the designed parameter of the engine configuration, including primary and secondary flows. The main flow is the flow of the thermodynamic cycle, and the secondary flow to ensure cooling and escaping of the engine at a specified position. In addition, the structure of the auxiliary system needs to be determined, and the lubrication system is taken from separate or fuel.

Step 2: Define thermodynamic cycle of the engine in detail

At this step, some parameters should be identified as follows:

Whether a compressor and turbine operation map exists. Performance maps of compressors and turbines are often not provided by the manufacturer. With regard to the cost of testing and the importance of the map in determining operation as well as engine modeling, where a compressor and turbine operation map exists, the modeling steps would be a lot easier. But in most cases, even if the jet engine was directly designed and built by the design team, the existence of the map depends on the funding as well as the ability to conduct high-precision tests and require these expensive measuring devices.

Compression ratio and efficiency of compressors and turbines at the design point. This information is usually available before designing an engine. So in the role of the modeler, this information will be provided.

Turbine inlet temperature at design point. This information is available at an average level. Because of its importance in determining the thermodynamic cycle, errors in the temperature before turbines lead to other results in the equilibrium equation between the compressor and the turbine, giving the original equation for all engine performance calculations.

Flow coefficient of the nozzle. The flow coefficient of the nozzle plays an important role in balancing the air volume per unit time between the turbine and nozzle. This value affects the thrust of the engine, the temperature after the turbine. These two values are usually measured in the test rig, so if it is desired for the model to stick to the actual value but properly describe the inner workings, the flow coefficient of the throttle is important. The flow coefficient will be a proportional curve between the ratio of pressure and flow through the throttle.

Power consumption of auxiliary system. Power consumption of the auxiliary system includes power generation system, fuel pump system, engine oil pump taken from the engine shaft. Usually the total consumption of the auxiliary system accounts for 1% of the motor shaft power.

Total pressure loss at the ducts and at the combustion chamber. This main airway effect reduces the pressure before each component module depending on the pressure drop value. If no information is available, this value is usually set to 0.95 . . . 0.99.

Step 3: Put information and data of the engine into the corresponding component module blocks, multi-loop model structure and engine test run at the design point in a steady state.

Each component module block is packaged in SIMULINK, allowing the user to communicate with input parameters from outside the computational block if it is not necessary to intervene deeply into the internal structure. The parameters are given in the form of matrices, and the size of the matrix between blocks should comply with the model's requirements. If the matrix dimensions do not comply properly, the operation of the model will immediately report an error because the operations on the matrix cannot be performed.

In case the design parameters do not provide the test parameters at the test rig, the modeler needs to customize the parameters as well as review whether the information provided by the manufacturer is trusted or not? This is the most time-consuming step in modeling, and an understanding of the engine's operation is required to change these parameters. This is the step to determine the maximum operating point or maximum power according to the design.

Step 4: From the whole engine state at the starting point, save the sample as an input to the dynamic model, describe the engine operation between the two stable operating points.

Dynamic model is the model derived from the static point defined in step 3. It is necessary to put the whole initial state in the static model to switch to the dynamic model. In addition, at this step, a combustion chamber activity map should be provided from the combustion chamber design team to model the performance of fire at locations outside the design point.

Step 5: Compare test data to give errors of the model.

Change unknown values to complete the model. Test data may be given in a continuous form, either individually for each operating point, of an engine or of multiple motors. The fact that aligning the model properly with an engine is a time-consuming process that requires the designer to understand the structure of the model. Comparison results often lead to deviations in the turbine temperature and engine thrust at low rotation speed points. The operating amplitude of a turbine compressor or combustion chamber at low speed points is often greater than the deviation from the design point. Therefore, there should be methods to change the shape of the map at low speed roads.

1. The method of building a single-spool turbojet engine modeling comprises of five steps, of which:
Step 1: determine the structure of a turbojet engine modeled; at this step, the structure of the turbojet engine is modeled including a number of spindle, continuous exhaust mode and exhaust mode, with afterburning mode, power consumption for auxiliary components, environmental conditions parameters; the structure determination is based on a designer's grasp of a configuration of the turbojet engine, including primary and secondary flows;
Step 2: Determine a thermodynamic cycle of the engine in detail; at this step, some information should be identified as follows:
Whether a compressor and turbine operation map exists; The compressor and turbine operation map is information not normally provided by the manufacturer;
Compression ratio and efficiency of compressors and turbines at a design point; this is the information that is usually available before designing an engine;
Turbine inlet temperature at design point; this information is available at an average level;
Mass flow rate of turbojet engine; Mass flow rate of turbojet engine plays an important role in balancing the air volume per unit time between the turbine and the compressor; this value affects the thrust of the engine, a temperature after the turbine;
Power consumption of the auxiliary system; power consumption of auxiliary systems, including power generation system, fuel pump system, engine oil pump taken from the engine shaft;
Total pressure loss at transfer points and at a combustion chamber; This main airway effect reduces the pressure before each component module depending on the pressure drop value; if no information is available, this value is usually set to 0.95 . . . 0.99;
Step 3: Put the engine information and data into corresponding component module blocks, multi-loop model structure and engine test run at the design point in a steady state; At this step, the parameters are given in the form of matrix, and a size of matrix between blocks needs to comply with the model's requirements; In case the anticipated parameters of the designer do not provide the parameters of the test at a test price, the modeler needs to customize those parameters as well as review the parameters provided by the manufacturer with information to trust or not; This is the step to determine the maximum operating point or maximum capacity according to the design;
Step 4: From the entire engine state at a starting point, save a sample as input to a dynamic model, describe the engine operation between the two stable operating points; At this step, it is necessary to put an entire initial state in a static model to switch to the dynamic model; In addition, a combustion chamber operation map should be provided from a combustion chamber design team to model the performance of fire at points outside the design point;
Step 5: compare test data showing model errors and change unknown values to complete the model; At this step, test data may be given in a continuous form, either individually for each operating point, for one engine or for many engines; Comparison results often lead to deviations of turbine temperature and engine thrust at low rotation speed points; The operating properties of a turbine compressor or combustion chamber at low speed points is often greater than the deviation from the design point, so unknown values need to be changed to complete the model.
